(19) United States
(12) Patent Application Publication
(10) Pub. No.: US 2014/0281981 A1
(43) Pub. Date: Sep. 18, 2014

(54) ENABLING MUSIC LISTENER FEEDBACK

(71) Applicant: Yoshinari Yoshikawa, Los Altos, CA (US)

(72) Inventor: Yoshinari Yoshikawa, Los Altos, CA (US)

(73) Assignee: Miselu, Inc, San Francisco, CA (US)

(21) Appl. No.: 13/840,837

(22) Filed: Mar. 15, 2013

(51) Int. Cl. G06F 3/16; G06F 3/0482

(52) U.S. Cl. CPC G06F 3/162; G06F 3/0482
USPC 715/716

(57) ABSTRACT

Embodiments generally relate to enabling music listener feedback. In one embodiment, a method includes converting an audio signal into a graphical representation, and causing the graphical representation to be displayed to a user. The method also includes enabling the user to provide listener feedback associated with one or more predetermined aspects of the audio signal, and causing the listener feedback to be displayed in the graphical representation.

### BACKGROUND

The creation of music is a popular activity enjoyed by many people. Some music applications enable a listener to provide listener feedback on music. For example, a music application may enable a listener to indicate a like or a dislike of a particular song. Some music applications enable listeners to provide comments on particular songs. Such like and dislike indications and other comments may be shared with other users.

### SUMMARY

Embodiments generally relate to enabling music listener feedback on music. In one embodiment, a method includes converting an audio signal into a graphical representation, and causing the graphical representation to be displayed to a user. The method also includes enabling the user to provide listener feedback associated with one or more predetermined aspects of the audio signal, and causing the listener feedback to be displayed in the graphical representation.

In another embodiment, an apparatus includes one or more processors, and includes logic encoded in one or more tangible media for execution by the one or more processors. When executed, the logic is operable to perform operations including converting an audio signal into a graphical representation, and causing the graphical representation to be displayed to a user. The logic is operable to perform operations including enabling the user to provide listener feedback associated with one or more predetermined aspects of the audio signal, and causing the listener feedback to be displayed in the graphical representation.

### BRIEF DESCRIPTION OF THE DRAWINGS

FIG. 1 is a block diagram of an example system, which may be used to implement the embodiments described herein.

FIG. 2 illustrates an example simplified flow diagram for enabling listener feedback on a music piece, according to some embodiments.

FIG. 3 illustrates an example simplified flow diagram for enabling listener feedback on a music piece, according to some embodiments.

FIG. 4 illustrates an example simplified diagram for displaying listener feedback in a graphical representation of a music piece, according to some embodiments.

### DETAILED DESCRIPTION

Embodiments described herein enable advanced music listener feedback on music. As described in more detail below, a system enables listeners of music to provide listener feedback on music, where such listener feedback may include their appreciation and/or recommendations with regard various aspects of such music.

In some embodiments, the system converts an audio signal of music into a graphical representation and displays the graphical representation to a listener. In various embodiments, the system enables the listener to provide listener feedback associated with the entire audio signal and/or associated with different aspects of the audio signal. The system displays the listener feedback in appropriate locations in the graphical representation, where the listener who provides the listener feedback, other listeners, and/or people associated with the creation of the audio signal may view the listener feedback in the context of the audio signal. As a result, the listener is enabled to conveniently provide useful and specific listener feedback on the audio signal.

FIG. 1 is a block diagram of an example system 100, which may be used to implement the embodiments described herein. In some implementations, computer system 100 may include a processor 102, an operating system 104, a memory 106, a music application 108, a network connection 110, a microphone 112, a touchscreen 114, and a speaker 116. For ease of illustration, the blocks shown in FIG. 1 may each represent multiple units. In other embodiments, system 100 may not have all of the components shown and/or may have other elements including other types of elements instead of, or in addition to, those shown herein.

Music application 108 may be stored on memory 106 or on any other suitable storage location or computer-readable medium. Music application 108 provides instructions that enable processor 102 to perform the functions described herein. In various embodiments, music application 108 may run on any electronic device including smart phones, tablets, computers, etc.

In various embodiments, touchscreen 114 may include any suitable interactive display surface or electronic visual display that can detect the presence and location of a touch within the display area. Touchscreen 114 may support touching the display with a finger or hand, or any suitable passive object, such as a stylus. Any suitable display technology (e.g., liquid crystal display (LCD), light emitting diode (LED), etc.) can be employed in touchscreen 114. In addition, touchscreen 114 in particular embodiments may utilize any type of touch detecting technology (e.g., resistive, surface acoustic wave (SAW) technology that uses ultrasonic waves that pass over the touchscreen panel, a capacitive touchscreen with an insulator, such as glass, coated with a transparent conductor, such as indium tin oxide (ITO), surface capacitance, mutual capacitance, self-capacitance, projected capacitive touch (PCT) technology, infrared touchscreen technology, optical imaging, dispersive signal technology, acoustic pulse recognition, etc.).

In various embodiments, processor 102 may be any suitable processor or controller (e.g., a central processing unit (CPU), a general-purpose microprocessor, a microcontroller, a microprocessor, etc.). Further, operating system 104 may be any suitable operating system (OS), or mobile OS/platform, and may be utilized to manage operation of processor 102, as well as execution of various application software. Examples of operating systems include Android from Google, iPhone OS (iOS), Berkeley software distribution (BSD), Linux, Mac OS X, Microsoft Windows, and UNIX.

In various embodiments, memory 106 may be used for instruction and/or data memory, as well as to store music and/or video files created on or downloaded to system 100. Memory 106 may be implemented in one or more of any number of suitable types of memory (e.g., static random access memory (SRAM), dynamic RAM (DRAM), electrically erasable programmable read-only memory (EEPROM), etc.). Memory 106 may also include or be combined with removable memory, such as memory sticks (e.g., using flash memory), storage discs (e.g., compact discs, digital video discs (DVDs), Blu-ray discs, etc.), and the like. Interfaces to memory 106 for such removable memory may include a universal serial bus (USB), and may be implemented through a separate connection and/or via network connection 110.

In various embodiments, network connection 110 may be used to connect other devices and/or instruments to system 100. For example, network connection 110 can be used for wireless connectivity (e.g., Wi-Fi, Bluetooth, etc.) to the Internet (e.g., navigable via touchscreen 114), or to another device. Network connection 110 may represent various types of connection ports to accommodate corresponding devices or types of connections. For example, additional speakers (e.g., Jawbone wireless speakers, or directly connected speakers) can be added via network connection 110. Also, headphones via the headphone jack can also be added directly, or via wireless interface. Network connection 110 can also include a USB interface to connect with any USB-based device.

In various embodiments, network connection 110 may also allow for connection to the Internet to enable processor 102 to send and receive music over the Internet. As described in more detail below, in some embodiments, processor 102 may generate various instrument sounds coupled together to provide music over a common stream via network connection 110.

In various embodiments, speaker 116 may be used to play sounds and melodies generated by processor 102. Speaker 116 may also be supplemented with additional external speakers connected via network connection 110, or multiplexed with such external speakers or headphones.

While processor 102 is described as performing the steps as described in the embodiments herein, any suitable component or combination of components of system 100 or any suitable processor or processors associated with system 100 or any suitable system may perform the steps described.

FIG. 2 illustrates an example simplified flow diagram for enabling listener feedback on a music piece, according to some embodiments. Referring to both FIGS. 1 and 2, a method is initiated in block 202 where processor 102 of system 100 converts an audio signal into a graphical representation. In various embodiments, the audio signal may include a music piece or any other sound or sound stream. As such, the phrase “audio signal” may be used interchangeably with the phrase “music piece,” or terms “music,” “song,” “melody,” etc. In some embodiments, the audio signal may be any sound input that is received in the form of sound waves. Such sound input may also be received in the form of an audio file.

In various implementations, processor 102 may receive the audio signal via any suitable input device such as a network connection, memory device, etc. In various implementations, processor 102 may receive the audio signal from an audio file containing music.

In various embodiments, the graphical representation may take various forms. For example, in various embodiments, processor 102 may generate a graphical representation that includes an x-axis corresponding to pitch and a y-axis corresponding to time, where a melody and/or other components of an audio signal/music piece has a form that is a graph of pitch with respect to time.

In various embodiments, processor 102 may generate a graphical representation that ranges from simple to complex, depending on the specific implementation. For example, in some embodiments, processor 102 may generate a graphical representation that includes traditional musical notation or any other specific notation. For example, in some embodiments, processor 102 may generate a music staff of five horizontal lines and four spaces, which represent a musical pitch. Processor 102 may generate music symbols such as whole notes, half notes, quarter notes, etc., in appropriate positions on the music staff based on the primary melody.

In block 204, processor 102 causes the graphical representation to be displayed to a user. For example, processor 102 may cause the graphical representation to be displayed on the display screen of a mobile device such as a cell phone, and/or on the display screen of any other type of electronic device such as a tablet, notebook computer, desktop computer, musical device or instruments, etc. For ease of illustration, the term “user” as used in various embodiments described herein refers primarily to a user who listens to the audio signal and provides feedback on the audio signal. In different contexts, the term “user” may also refer to any other listener of the audio signal and may also refer to a person associated with creating the audio signal, as processor 102 may enable any of such people to provided listener feedback on any given audio signal.

In block 206, processor 102 enables the user to provide listener feedback associated with one or more predetermined aspects of the audio signal. As described in more detail below in connection with FIG. 3, embodiments enable the user to provide a combination of binary listener feedback (e.g., like/dislike, approve/disapprove, “+”/“−”, etc.) and/or non-binary listener feedback (e.g., iconic/menu driven listener feedback using specific musical terminology). Furthermore, embodiments enable the user to provide various types of listener feedback (e.g., general listener feedback, time-specific listener feedback, channel-specific listener feedback, performer-specific listener feedback, etc.). In some implementations, the listener feedback may also include emoticons. Such listener feedback indicates how listeners and audiences experience the music piece. Further embodiments related to enabling listener feedback on a music piece are described in more detail below in connection with FIG. 3.

In some implementations, the listener feedback may include one or more recommendations, where processor 102 enables the user to associate the one or more recommendations with the audio signal. For example, in some embodiments, the listener feedback may recommend one or more modifications to pitch (e.g., sharp/flat notification). The listener feedback may also recommend one or more modifications to volume (e.g., diminuendo, crescendo, etc.). The listener feedback may also recommend one or more modifications to emphasis (e.g., accentuato, gustoso, etc.). The listener feedback may also recommend one or more modifications to timing (e.g., allegro, lentissimo, etc.). The listener feedback may also recommend one or more modifications to voice (e.g., bass, tenor, alto, soprano, etc.). The listener feedback may also recommend the addition of one or more tracks or other portions of the audio signal. The listener feedback may also recommend the removal of one or more tracks or other portions of the audio signal. The listener feedback may also recommend one or more modifications to instrumentation. The listener feedback may also recommend one or more modifications to production, including choice of effects processing and choice of settings for processing effects. In some implementations, the listener feedback may also recommend one or more modifications to lyrical content, rhythmic content, emotional context, and/or melodic content.

In some implementations, processor 102 may enable the user provide particular listener feedback based on predetermined currencies established by the user. For example, in some implementations, processor 102 may required that the user expend a minimum predetermined amount of currency in order to provide certain types of listener feedback. Such currency may be in the form of a minimum number of prior listener feedback information given in the past, particular types of listener feedback given in the past, etc. Such currency may be in the form of points, where the user may allocate points to various feedback instances and various types of listener feedback. In some implementations, processor 102 may allocate a predetermined number of points (e.g., per music piece/audio signal).

In various embodiments, the user may be any listener of the audio signal/music. In some scenarios, the user may provide listener feedback to the creator of the audio signal (e.g., the musician). In some scenarios, the user may also be the musician/creator of the music or any person associated with the creator. In such scenarios, the creator and/or any associated person (e.g., distributor, producer, etc.), may utilize embodiments described herein to listen to an audio signal/music piece after being created, and then comment in order to facilitate in modifying and refining the music piece. For ease of illustration, embodiments herein are described in the context of any listener of the music providing listener feedback. Also, the recipient of such listener feedback may be any user, such as the creator of the music or anyone associated with the creation of the music, any other listeners, and/or even to provide notes/comments to the user originating the listener feedback (e.g., for review and/or future reference).

In some implementations, to enable the listener to provide the various types of listener feedback described herein, processor 102 enables the user to select one or more listener feedback selections from a listener feedback menu. In some implementations, processor 102 may enable the user to select among a set of notations made through a menu of predetermined options. In some implementations, one or more of the listener feedback selections may be associated with one or more predetermined listener feedback notations.

Referring again to FIG. 2, in block 208, processor 102 causes the listener feedback to be displayed in the graphical representation. In various implementations, processor 102 may display the listener feedback in one or more portions of the graphical representation, which may occur as processor 102 receives listener feedback selections. In some implementations, the one or more of the portions of the graphical representation may be predetermined portions, which may be defined in various ways depending on the particular implementation. For example, one or more of the portions of the graphical representation may be associated with one or more corresponding predetermined aspects of the audio signal. Further embodiments related to displaying listener feedback in a graphical representation are described in more detail below in connection with FIG. 4.

In various implementations, processor 102 causes the graphical representation along with the listener feedback to be displayed to the user and to one or more other users. As indicated above, the one or more other users may include other listeners as well as any person involved in the creation, production, and/or distribution of the audio signal. In other words, the one or more other users may include any one or more people associated with the creation, production, and/or distribution of the audio signal. Such people may include, for example, distributors of the audio signal, producers of the audio signal, and/or creators of the audio signal (e.g., musicians).

In various embodiments, processor 102 enables the user to associate a link to another audio signal. As a result, the listener feedback may include a link to another audio signal. In some embodiments, the listener feedback may include a comparison between the audio signal and contents associated with the other audio signal associated with the link. The comparison may include information in the form of open text and/or in the form of any of the listener feedback described herein. For example, processor 102 may recommend listening to a particular portion of an audio signal/music piece via the link for modification possibilities, etc.

For ease of illustration, some embodiments are described herein in the context of one audio signal. These embodiments also apply to multiple audio signals. The audio signals may be associated with a set of respective visual representations of the audio signal(s).

FIG. 3 illustrates an example simplified flow diagram for enabling listener feedback on a music piece, according to some embodiments. As shown, in various embodiments, processor 102 causes the graphical representation 310 to be displayed in a user interface 320.

In various embodiments, processor 102 may enable the user to provide general listener feedback 322 on an entire music piece. For example, processor 102 may enable the user to provide general positive or negative listener feedback 324 (e.g., +/−karma) on the entire music piece. Processor 102 may also enable the user to provide general listener feedback 326 on the entire music piece using musical notation. Such musical notation may include any musical notation encountered in printed scores, music reviews, and program notes (e.g., fortissimo, grandioso, presto, etc.). In various implementations, the musical notation used for general listener feedback may be specific musical notation or alternative musical notation. Processor 102 may also enable the user to provide general listener feedback 328 on the entire music piece using an open format (e.g., open text annotation, comments, etc.).

In various implementations, processor 102 may enable the user to provide specific listener feedback 332 on specific aspects and/or portions of the music piece. For example, processor 102 may enable the user to provide specific positive or negative listener feedback 334 (e.g., +/−karma) on one or more points and/or one or more portions of the music piece. Processor 102 may also enable the user to provide specific listener feedback 336 on one or more points and/or one or more portions of the music piece using musical notation. In various implementations, the musical notation used for general listener feedback may be specific musical notation or alternative musical notation. Processor 102 may enable the user to provide specific listener feedback 338 on one or more points and/or one or more portions of a music piece using an open format (e.g., open text annotation, comments, etc.).

In various implementations, the one or more points and/or one or more portions of the music piece may refer to various aspects of the music piece. For example, a particular point or portion may be a time-specific point (e.g., point in time in the music piece) or time-specific portion (e.g., range of time in the music piece). In another example, a particular point or portion may be a channel-specific point (e.g., particular channel in the music piece) or channel-specific portion (e.g., multiple channels in the music piece). Other aspects of the music piece may also include one or more specific performer contributions to the music piece.

FIG. 4 illustrates an example simplified diagram 400 for displaying listener feedback in a graphical representation of a music piece, according to some embodiments. In various embodiments, processor 102 causes a graphical representation 410 of the music piece to be displayed in a user interface 420. Furthermore, processor 102 causes the graphical representation 410 to be displayed with various listener feedback, whether general listener feedback to an entire music piece or specific listener feedback to different points and/or portions of a music piece.

In various embodiments, processor 102 may cause general listener feedback to be displayed in any suitable location in user interface 420. For example, processor 102 may cause general positive or negative listener feedback 424 on the entire music piece, general listener feedback 426 on the entire music piece using musical notation, general listener feedback 428 on the entire music piece using an open format to be displayed at the beginning and/or end of the music piece, or another other suitable location in user interface 420.

In various implementations, processor 102 may cause specific listener feedback to be displayed in any suitable location in user interface 420. For example, processor 102 may cause specific positive or negative listener feedback 434 on one or more points and/or one or more portions of the music piece, specific listener feedback 436 on one or more points and/or one or more portions of the music piece using musical notation, specific listener feedback 438 on one or more points and/or one or more portions of a music piece using an open format to be displayed specifically at the one or more points and/or one or more portions of the music piece.

As indicated above in connection with FIG. 3, in various implementations, the one or more points and/or one or more portions of the music piece may refer to various aspects of the music piece. For example, a particular point or portion may be a time-specific point (e.g., point in time in the music piece) or time-specific portion (e.g., range of time in the music piece). In another example, a particular point or portion may be a channel-specific point (e.g., particular channel in the music piece) or channel-specific portion (e.g., multiple channels in the music piece).

Embodiments described herein provide various benefits. For example, embodiments enable a listener of a piece of music to provide useful listener feedback regarding the music to the creator of the music. Embodiments also provide simple and intuitive selections for providing such listener feedback.

Although the description has been described with respect to particular embodiments thereof, these particular embodiments are merely illustrative, and not restrictive. Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method comprising:
converting an audio signal into a graphical representation;
causing the graphical representation to be displayed to a user;
enabling the user to provide listener feedback associated with one or more predetermined aspects of the audio signal; and
causing the listener feedback to be displayed in the graphical representation.

2. The method of claim 1, wherein the listener feedback is displayed in one or more portions of the graphical representation, and wherein the one or more portions are associated with one or more corresponding predetermined aspects of the audio signal.

3. The method of claim 1, wherein the enabling of the user to provide listener feedback comprises enabling the user to select one or more listener feedback selections from a listener feedback menu.

4. The method of claim 1, wherein the enabling of the user to provide listener feedback comprises enabling the user to select one or more listener feedback selections from a listener feedback menu, and wherein one or more of the listener feedback selections are associated with one or more predetermined listener feedback notations.

5. The method of claim 1, wherein the listener feedback comprises a link to a second audio signal.

6. The method of claim 1, wherein the listener feedback comprises one or more recommendations.

7. The method of claim 1, wherein the one or more other users includes other listener of the audio signal.

8. The method of claim 1, wherein the one or more other users includes one or more people associated with creating the audio signal.

9. A computer-readable storage medium carrying one or more sequences of instructions thereon, the instructions when executed by a processor cause the processor to perform operations comprising:
converting an audio signal into a graphical representation;
causing the graphical representation to be displayed to a user;
enabling the user to provide listener feedback associated with one or more predetermined aspects of the audio signal; and
causing the listener feedback to be displayed in the graphical representation.

10. The computer-readable storage medium of claim 9, wherein the listener feedback is displayed in one or more portions of the graphical representation, and wherein the one or more portions are associated with one or more corresponding predetermined aspects of the audio signal.

11. The computer-readable storage medium of claim 9, wherein the enabling of the user to provide listener feedback comprises enabling the user to select one or more listener feedback selections from a listener feedback menu.

12. The computer-readable storage medium of claim 9, wherein the enabling of the user to provide listener feedback comprises enabling the user to select one or more listener feedback selections from a listener feedback menu, and wherein one or more of the listener feedback selections are associated with one or more predetermined listener feedback notations.

13. The computer-readable storage medium of claim 9, wherein the listener feedback comprises a link to a second audio signal.

14. The computer-readable storage medium of claim 9, wherein the listener feedback comprises one or more recommendations.

15. The computer-readable storage medium of claim 9, wherein the one or more other users includes other listeners of the audio signal.

16. The computer-readable storage medium of claim 9, wherein the one or more other users includes one or more people associated with creating the audio signal.

17. An apparatus comprising:
one or more processors; and
logic encoded in one or more tangible media for execution by the one or more processors, and when executed operable to perform operations comprising:
converting an audio signal into a graphical representation;
causing the graphical representation to be displayed to a user;
enabling the user to provide listener feedback associated with one or more predetermined aspects of the audio signal; and
causing the listener feedback to be displayed in the graphical representation.

18. The apparatus of claim 17, wherein the listener feedback is displayed in one or more portions of the graphical representation, and wherein the one or more portions are associated with one or more corresponding predetermined aspects of the audio signal.

19. The apparatus of claim 17, wherein the enabling of the user to provide listener feedback comprises enabling the user to select one or more listener feedback selections from a listener feedback menu.

20. The apparatus of claim 17, wherein the enabling of the user to provide listener feedback comprises enabling the user to select one or more listener feedback selections from a listener feedback menu, and wherein one or more of the listener feedback selections are associated with one or more predetermined listener feedback notations.
